(19) United States
(12) Patent Application Publication
(10) Pub. No.: US 2013/0275292 A1
(43) Pub. Date: Oct. 17, 2013

(54) SYSTEMS AND METHODS FOR COMPETITIVE APR PRICING

(71) Applicants: Michael Cappucci, Crawford, NJ (US); Alexander Cook, New York, NY (US); Sona Grover, East Brunswick, NJ (US); Manish Gupta, Hawthorn, NJ (US); Li Huang, Rego Park, NY (US); Jean Paul Diegane Ndong, Mahwah, NJ (US); Charles Chen Song, New York, NY (US); Xiaodong Sun, Edison, NJ (US)

(72) Inventors: Michael Cappucci, Crawford, NJ (US); Alexander Cook, New York, NY (US); Sona Grover, East Brunswick, NJ (US); Manish Gupta, Hawthorn, NJ (US); Li Huang, Rego Park, NY (US); Jean Paul Diegane Ndong, Mahwah, NJ (US); Charles Chen Song, New York, NY (US); Xiaodong Sun, Edison, NJ (US)

(73) Assignee: American Express Travel Related Services Company Inc., New York, NY (US)

(21) Appl. No.: 13/449,132

(22) Filed: Apr. 17, 2012

(51) Int. Cl. G06Q 40/02

(52) U.S. Cl. 705/38

(57) ABSTRACT

A method is provided comprising receiving tradeline data associated with a consumer related to a tradeline, determining payment terms of the tradeline by selecting the greatest of a minimum potential payment amount, a fixed percentage potential payment amount, and a fixed percentage plus finance charge potential payment amount, and calculating (in response to selection of the fixed percentage plus finance charge potential payment amount) an APR of the tradeline.

### FIELD

The disclosure generally relates to financial analysis, and more particularly, to systems and methods for determining an annual percentage rate (APR), for example, from credit bureau data.

### BACKGROUND

Credit issuers often compete for consumers on the basis of interest rates. Lower interest rates attract consumers, but should be high enough to be profitable in relation to the risk of default. In many eases, it is not possible for a credit issuer to view a given consumer's existing debt obligations and their respective interest rates. Thus, it is difficult or impossible for a credit issuer to offer a consumer a lower interest rate because the consumer's existing interest rate is not known. Such uncertainty may lead to offers of an APR higher than the existing APR or an APR far lower than the existing APR, which would negatively affect profitability. It would thus be beneficial for a credit issuer to be able to determine interest rates on existing debt obligations of consumers.

### SUMMARY

Various systems and methods for fraud detection and data analysis are provided herein in various embodiments. A method (by an APR determining computer based system, wherein the computer based system comprises a processor and a tangible, non-transitory memory) is provided comprising receiving tradeline data associated with a consumer related to a tradeline, determining payment terms of the tradeline by selecting the greatest of a minimum potential payment amount, a fixed percentage potential payment amount, and a fixed percentage plus finance charge potential payment amount, and calculating (in response to the selection of the fixed percentage plus finance charge potential payment amount) an APR of the tradeline.

### BRIEF DESCRIPTION OF THE DRAWINGS

The above and other features and advantages are hereinafter described in the following detailed description of exemplary embodiments to be read in conjunction with the accompanying drawing figures, wherein like reference numerals are used to identify the same or similar parts in the similar views, and:

FIG. 1 illustrates a method, according to various embodiments;

FIG. 2 illustrates a method of determining payment terms, according to various embodiments;

FIG. 3 illustrates a method of calculating an APR, according to various embodiments;

FIG. 4 illustrates a method of using APR, according to various embodiments;

FIG. 5 illustrates a method of using APR, according to various embodiments;

FIG. 6 illustrates a graphical representation of relationships between payment terms.

### DETAILED DESCRIPTION

The detailed description of exemplary embodiments herein makes reference to the accompanying drawings, which show various embodiment by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment. Terms similar to “connect” may include a partial or full connection and/or a partial or full interface.

Systems, methods and computer program products are provided. In the detailed description herein, references to “one embodiment”, an embodiment”, an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles. The disclosure may be implemented as a method, system or in a computer readable medium.

As used herein, the term “consumer” may mean any person or entity that consumes or uses an item. As used herein, a customer may mean a person or entity that has purchased and/or may purchase in the future an item from a given business entity, such as a merchant. Thus, a customer list may be a list of people or entities that have purchased or may purchase an item from another entity, such as a merchant.

As used herein, APR or like terms may mean any rate (e.g., an annual percentage rate). An annual percentage rate may include the effective interest rate of a loan over an entire year.

Business entities (e.g., merchants) may improve their businesses by harnessing data related to their customers and consumers in general. Credit issuers may win business through the offering of competitive APR on loan products (e.g., revolving credit accounts, automobile loans, charge card accounts, etc). In addition, credit issuers may win business by offering competitive APR to consumers who transfer existing debt obligations (e.g., a balance transfer from one revolving account to another). In this manner, a credit issuer may obtain additional business while still maintaining profitability.

However, it is often difficult or impossible for a credit issuer to obtain the APR of a consumer's debt obligations. Stated another way, a credit issuer often may not be able to obtain direct knowledge of the APR of a consumer's debt obligations. Credit bureau data, as described herein, typically does not contain a field for APR. Thus, obtaining tradeline data for a consumer does not provide direct knowledge of an APR for an existing tradeline. Tradeline data for a consumer is often obtained upon the application for a new line of credit, and in certain circumstances may be obtained in association with a relationship with a consumer.

With reference to FIG. 1, APR determination method 100 is illustrated. In Step 102, tradeline data is received. The tradeline data may comprise information regarding one or more tradelines for a given consumer. A tradeline, as discussed herein, may be a revolving account (e.g., a credit card account or a home equity line of credit (“HELOC”)), a charge card account, or an installment account such an automobile loan, a mortgage, personal loan or home equity loan. As discussed above, tradeline data does not provide direct knowledge of an APR for an existing tradeline. The tradeline data may be received from any credit bureau or a third party that otherwise retains or distributes tradeline data. The tradeline data may comprise a minimum payment amount due for a given month as well as a balance amount.

In Step 104, payment terms are determined. A debt obligation may entail various payment terms. Payment terms may include the manner, method, and timing of repayments. Many debt obligations have a minimum payment amount. The minimum payment amount may comprise an amount that the credit issuer will accept on a monthly basis, generally without triggering a negative reporting event to a credit bureau.

Credit issuers that issue revolving accounts typically require that a consumer pay a minimum payment each month that is the maximum of three payment term calculations. Each of the three payment term calculations produces a minimum potential payment amount. The greatest of the three minimum potential payment amounts is typically selected as the minimum payment amount.

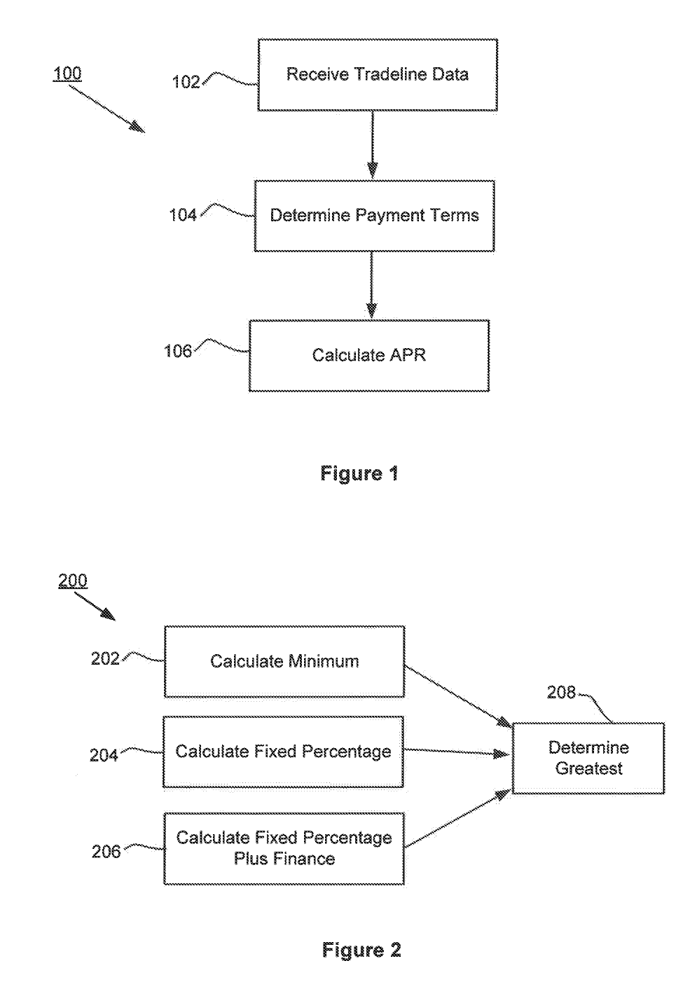

With momentary reference to FIG. 2, payment term determination method 200 is illustrated. The first payment term calculation is a “min-min” calculation. The “min-min” calculation is typically a fixed payment amount, regardless of balance or interest/finance charges. For example, a “min-min” could be X dollars per month and, typically is between about $10/month and $50/month. In such cases, the minimum potential payment amount may be from about $10/month to $50/month. In Step 202, the “min min” is calculated. For example, it may be found that the credit issuer of the tradeline uses a “min min” of $10. Thus, the “min min” minimum potential payment amounts is $10.

The second payment term calculation is a “X % Balance” calculation, also referred to as a fixed percentage calculation. The “X % Balance” calculation is typically a fixed percentage of the total outstanding balance, regardless of interest/finance charges. The percentage is typically from about 0.5% to about 3%, though any percentage is contemplated herein. For example, a “X % Balance” could be 2% of the balance per month. A consumer with a $1000 balance would thus have a minimum potential payment amount of $20, as $20 is 2% of $1000. As is evident, as balances grow, the “X % Balance” tends to yield higher minimum potential payment amounts than the “min-min” payment term calculation. Indeed, balances over $5,000 tend to provide higher minimum potential payment amounts for the “X % Balance” payment term calculation than the “min-min” payment term calculation. In Step 204, the “X % Balance” is calculated. For example, it may be found that the credit issuer of the tradeline uses a 2% balance, so a $1,000 balance would have a minimum potential payment amount of $20. The particular percentage of the balance in this calculation may be obtained from a credit issuer's web site or a third party data provider. A credit issuer may have a different term for each credit product, so each particular balance may be matched to the particular credit product of the tradeline.

The third payment term calculation is a “Y % Balance+Finance Charge” calculation, also referred to a fixed percentage plus finance. The “Y % Balance+Finance Charge” calculation is typically a fixed percentage of the total outstanding balance plus finance charges. The Y percentage is typically from about 0.5% to about 3%, though any percentage is contemplated herein. For example, a “Y % Balance+Finance Charge” could be 1% of the balance per month, plus finance charges. Finance charges, as used in this example, includes all or a portion of the interest charged on the balance plus applicable fees such as late fees, past due fees, and overlimit fees. Late fees and past due fees are typically assessed for untimely payments. Overlimit fees are typically assessed in response to a consumer exceeding a preset spending limit or credit limit.

In Step 206, the “Y % Balance+Finance Charge” is calculated. A consumer with a $1000 balance, where Y=1% and $20 in finance charges would thus have a minimum potential payment amount of $30, as $10 is 1% of $1000, plus $20. As in the “X % Balance” calculation, the particular percentage of the balance in this calculation may be obtained from a credit issuer's web site or a third party data provider. A credit issuer may have a different term for each credit product, so each particular balance may be matched to the particular credit product of the tradeline.

As is evident, as balances grow, the “Y % Balance+Finance Charge” tends to yield higher minimum potential payment amounts than the “X % Balance” payment term calculation and the “min-min” payment term calculation. Of course, this relationship changes as individual credit issuer terms change.

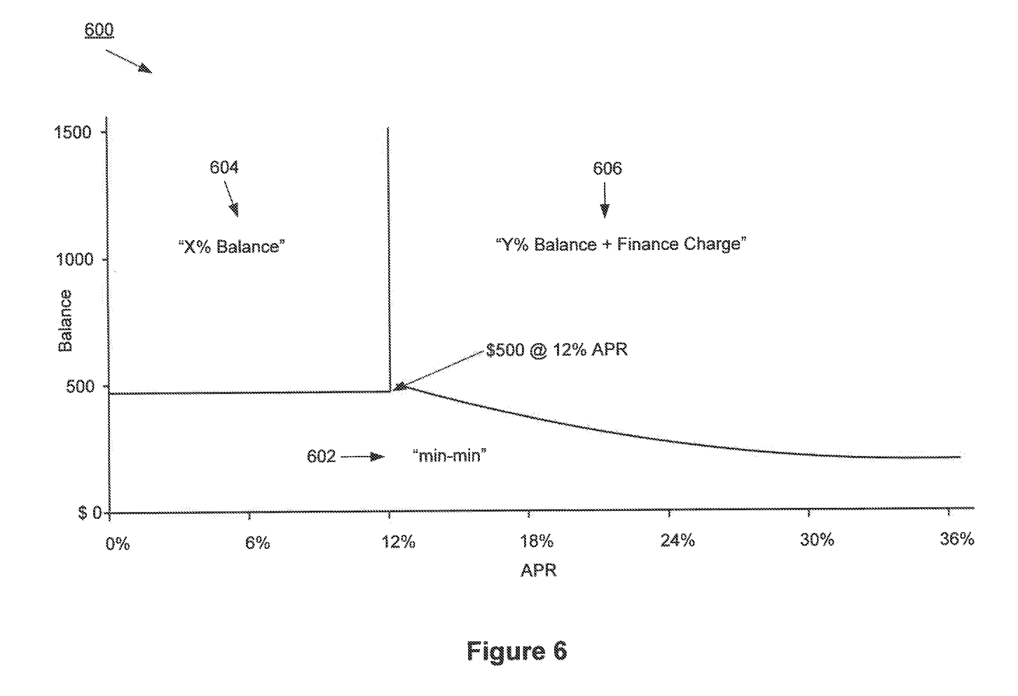

With reference to FIG. 6, relationship 600 illustrates the relationship between different payment terms for a particular credit issuer. In FIG. 6, APR is shown as increasing along the x axis. Balance is shown increasing along the y axis. The lines show the intersection of which payment term becomes the greatest payment term for each combination of APR and balance. Stated another way, the lines show which APR and balance combination would drive the selection of the payment terms.

For example, area 602 illustrates the “min-min” area. APR and balance combinations in this area receive a minimum payment as calculated by the “min-min” calculation. As shown, area 602 comprises consumers who have low balances (e.g., below or well below $500) receive a minimum payment using the “min-min” calculations.

Area 604 illustrates the “X % Balance” area. APR and balance combinations in this area receive a minimum payment as calculated by the “X % Balance” calculation. As shown, area 604 comprises consumers who have higher balances (e.g., above $500) but a lower APR (e.g., below 12%).

Area 606 illustrates the “Y % Balance+Finance Charge” area. APR and balance combinations in this area receive a minimum payment as calculated by the “Y % Balance+Finance Charge” calculation. As shown, area 606 comprises consumers who have higher balances (e.g., above $500) and a higher APR (e.g., above 12%).

As FIG. 6 illustrates, the “Y % Balance+Finance Charge” is typically used for the consumer who has higher balances and higher APRs. This is an area where another credit issuer may be able to offer a somewhat lower APR to win the business of the consumer (e.g., through balance transfer or increased use of a transaction card) and still retain profitability given the outstanding balance.

For each consumer during a period (e.g., each month), a credit issuer may typically calculate each of the above three minimum potential payment amounts and select the highest value as the minimum payment amount. Thus, if a minimum payment amount and balance are known, one may calculate each of the three minimum potential payment amounts. By matching the known minimum payment amount with the greatest minimum potential payment amount, the payment terms may be identified. Thus, in Step 208, the greatest minimum potential payment amount is determined and set to the minimum payment amount.

With reference back to FIG. 1, once the minimum payment amount is determined. Step 106 provides for calculating the APR. If the minimum payment amount is derived from the “min min” calculation or the “X % Balance” calculation, it would be difficult or impossible to determine APR because the APR is not used to set the minimum payment amount. However, in response to determining that the “Y % Balance+Finance Charge” calculation is used, the APR may be determined from the minimum payment.

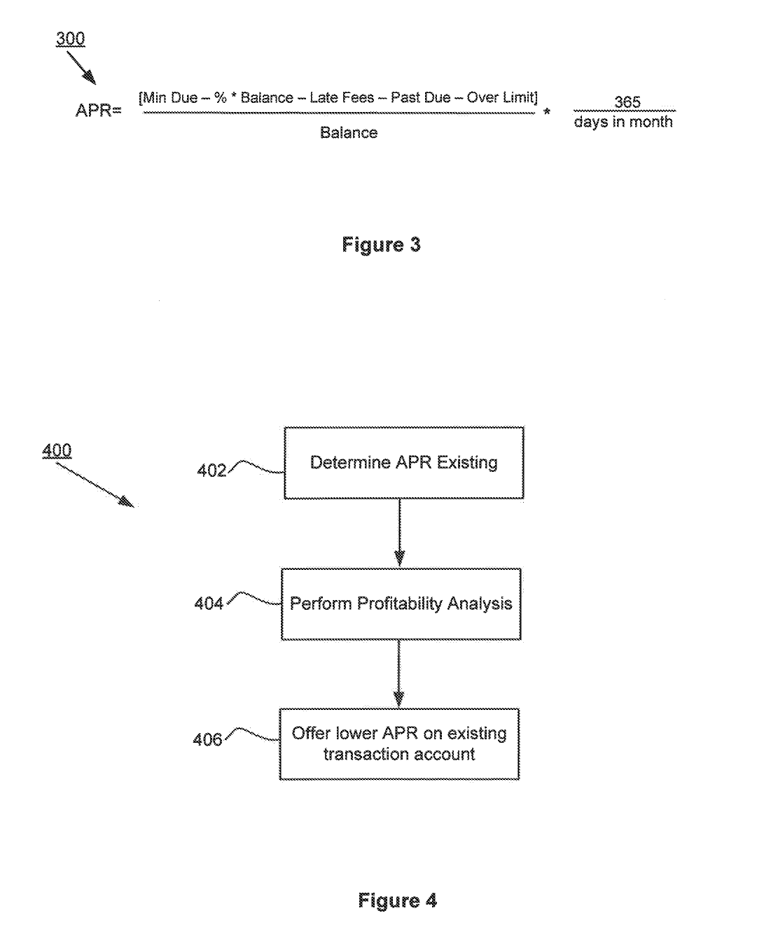

With reference to FIG. 3, an equation for determining APR 300 is shown. The equation shows that the APR may be found by taking the minimum payment amount and subtracting the percentage of balance included in the minimum payment. Late fees, past due fees, and overlimit amounts are also subtracted. The result is divided by the balance and multiplied by the 365 divided by the number of days in the month reported. This calculation results in the APR.

Other equations may be used for other types of loans. Mortgage APR may be determined from the mortgage term, the number of payments made, the payment amounts, any late fees or penalty fees, and the mortgage balance. Automobile APR may be determined from balance amount, length of loan, number of payments made, and any late fees or penalty fees. For example, for a home equity loan, the original amount, repayment term (i.e., length of loan), the number of payments made, months remaining in the repayment term, and current balance may be used to find APR. The APR of home equity lines of credit (HELOC) may be determined using methods described above with regard to transaction accounts (e.g., revolving accounts).

Also for example, for an automobile loan, the original amount, repayment term (i.e., length of loan), the number of payments made, months remaining in the repayment term, and current balance may be used to find APR.

For example, credit bureau data may show that for a given revolving account, a minimum payment is $427 and a balance is $20,065. In various embodiments, three calculations are performed to minimum potential payment amounts and then the greatest minimum potential payment amount is used to identify the payment terms.

In the present example, it may be determined that the credit issuer uses a “min-min” of $10, 2% of balance or 1% of balance plus finance charges. Thus, the “min-min” minimum potential payment amount is $10. The 2% of balance is $401. However, the credit bureau data included a minimum payment of $427. Thus, it is determined that the 1% of balance plus finance charges minimum potential payment amount was used to determine the payment term.

The equation of FIG. 3 may be applied using the minimum payment of $427 and a balance of $20,065. This equation yields an APR of 13.29%.

Once the APR is determined, a business may use it for a variety of purposes. For example, an APR may be used as the basis for prescreening customers for various promotional offers, offering competitive pricing, and enhancing risk models. Offer method 400 is illustrated in FIG. 4. In step 402, an APR is determined for an existing debt obligation. As in the above example, an APR may be 13.29%, and may be determined from credit bureau data consistent with the methods disclosed herein, such as in FIGS. 1-3.

In step 404, a profitability analysis is performed. Thus, another credit issuer may assess the profit potential of the consumer. Stared another way, the credit issuer may assess the consumer credit score and other indicia of risk in light of a potential profit derived from the APR and other finance charges.

In step 406, a credit issuer may offer the consumer a lower APR to encourage the consumer to transfer the balance to that credit issuer. The lower APR, in this embodiment, is associated with an existing consumer transaction account. The offered APR may be low enough to encourage the consumer to transfer the balance, but not so low that profitability would be significantly impacted. For a given credit score, for example, a credit issuer may offer the consumer a balance transfer APR of 10% to encourage the consumer to transfer the balance, or the credit issuer may offer the consumer a balance transfer APR at a 2% promotional rate for six months and then a floating APR or a fixed APR after that period. In this manner, step 406 provides an opportunity to develop more business with a credit issuer's existing consumers. This builds consumer loyalty as well as increases revenue.

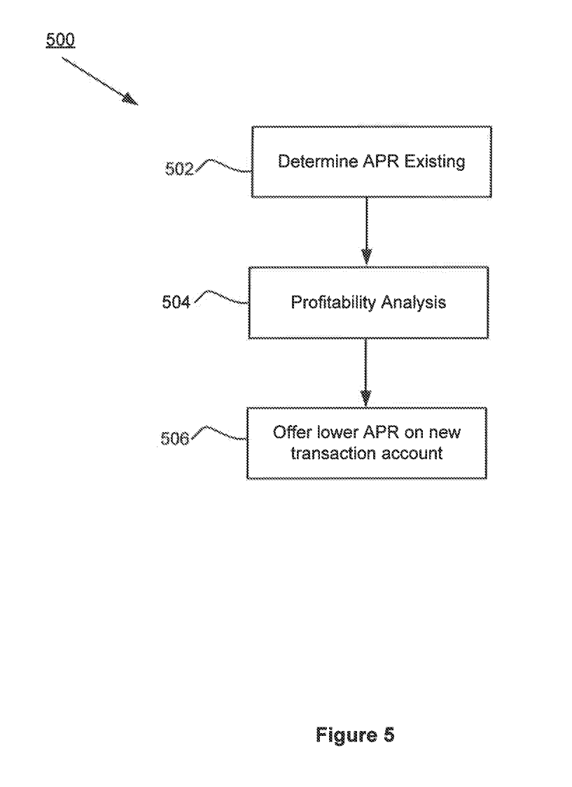

Also for example, offer method 500 is illustrated in FIG. 5. In step 502, an APR is determined for an existing debt obligation. As in the above example, an APR may be 13.29%, and may be determined from credit bureau data consistent with the methods disclosed herein, such as in FIGS. 1-3.

In step 504, a profitability analysis is performed. Thus, another credit issuer may assess the profit potential of the consumer. Stated another way, the credit issuer may assess the consumer credit score and other indicia of risk in light of a potential profit derived from the APR and other finance charges.

In step 506, a credit issuer may offer the consumer a new transaction account (e.g., a new revolving account) that is offered at a lower APR than the existing debt obligation. In this manner, the credit issuer may promote the use of its own revolving account against the consumer's existing one or more revolving accounts. In that regard, step 506 enables a credit issuer to win new business on a new revolving account.

“Internal data” and terms similar to “internal data” may include any data a credit issuer possesses or acquires pertaining to a particular consumer or group of consumers. Internal data may be gathered from a transaction system, such as a closed loop transaction system. Internal data may be gathered before, during, or after a relationship between the credit issuer and the transaction account holder (e.g., the consumer or buyer). Such data may include consumer demographic data. Consumer demographic data may include any data pertaining to a consumer. Consumer demographic data may include consumer name, gender, age, address (including ZIP code and 4 digit extension, also known as “ZIP+4”), telephone number, email address, employer and social security number. Consumer transactional data may include any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

In various embodiments, as discussed above, a node may contain internal data in a private facing data store, a public facing data store, or a combination thereof. In various embodiments, a node may contain internal data in a private facing data store and then a subset of the internal data in a public facing data store. For example, the internal data in a public facing data store may not contain personally identifiable information, or it may contain a summary of internal data found in the private facing data store, or it may contain data derived from internal data, such as size of wallet or share of wallet information. A size of wallet may comprise a measure of the amount a consumer spends using a credit, debit, and/or charge card. A share of wallet may comprise a measure of the relative share of a consumer's size of wallet that is spent in one industry or one merchant. A secure connection, such as secure channel 114, may be used to extract internal data from private facing data store into public facing data store.

Internal data placed in the public facing data store may be indexed or otherwise processed to preserve the underlying internal data as provide while still communicating valuable insight into a given consumer, consumer group, business, or industry. Such internal data may be referred to as processed internal data.

The internal data may be indexed, for example when stored in a public facing data store. For example, an index of data derived from internal data may comprise a measurement that relates the data to another data set. For example, the national average size of wallet of a consumer may be set arbitrarily at 100. A particular consumer may have an average size of wallet twice that of the national average and, thus, could have an indexed value of 200. In this manner, the indexed value could be placed in a public facing data store, so nodes that request this information do not receive the underlying data, but an indexed value as measured against a large pool of other consumers. Indexing may be useful in that is provides concrete trend information yet preserves specific aggregate data. In various embodiments, a large collection of internal data may exist on a node.

Internal data may also be processed to reflect the underlying data. For example, the internal data may comprise a metric that represents spend in various ranges over a given time period, such as the last quarter or year. As an example, a score of 5000 may indicate that ac consumer spent between $5000 and $6000 in the given time period. The internal data may include a range of numbers or a numeric indicator that indicates the trend of a consumer's spend over a given time period. For example, a trend score of +4 may indicate that the consumer has increased spending over the previous 4 months, while a trend score of −4 may indicate that the consumer has decreased spend over the previous 4 months. Further, aggregate data may be derived from the internal data relating to the purchasing of a population of transaction account users within a given industry.

The business cycle in each category may be divided into three phases: acquisition, retention, and disposal. The acquisition phase occurs when a business is attempting to gain new consumers. The acquisition phase includes, for example, targeted marketing, determining what items to offer a consumer, deciding whether to lend to a particular consumer and what the line size or loan should be, and deciding whether to buy a particular loan. The retention phase occurs after a consumer is already associated with the business. In the retention phase, the business interests shift to managing the consumer relationship through, for example, consideration of risk, determination of credit lines, cross-sell opportunities, increasing business from that consumer, and increasing the company's assets under management.

The disposal phase is entered when a business wishes to dissociate itself from a consumer or otherwise end the consumer relationship. The disposal phase can occur, for example, through settlement offers, collections, and sale of defaulted or near-default loans.

Financial services companies include, for example: banks and other lenders, mutual fund companies, financiers of leases and sales, life insurance companies, online brokerages, credit issuers, and loan buyers.

Banks and lenders can utilize the determination of an APR in all phases of the business cycle. The determination of an APR may be useful in issuing home equity lines of credit and automobile loans in a similar manner.

For example, if the holder of a home equity loan borrows from the capital market, the loan holder issues asset-backed securities (“ABS”), or bonds, which are backed by receivables. The loan holder is thus an ABS issuer. The ABS issuer applies for an ABS rating, which is assigned based on the credit quality of the underlying receivables. One of skill in the art will recognize that the ABS issuer may apply for the ABS rating through any application means without altering the spirit and scope of the present invention. In assigning a rating, the rating agencies weigh a loan's APR. High APR may indicate high potential profit by enhanced risk as higher APRs are often given to high risk debtors. Low APR may indicate low potential profit by reduced risk as lower APRs are often given to low risk debtors. Lenders generally secure higher ratings by credit enhancement. Examples of credit enhancement include over-collateralization, buying insurance (such as wrap insurance), and structuring ABS (through, for example, senior/subordinate bond structures, sequential pay vs. pari passu, etc.) to achieve higher ratings. Lenders and rating agencies may use certain characteristics of the APR of the underlying debt obligations into consideration when determining the appropriate level of credit enhancement. Thus, lenders and rating agencies, among others, may determine APR to assist in determining the appropriate level of credit enhancement.

During the acquisition phase of a loan, as discussed above, lenders may determine APR to improve their lending decisions. Before issuing the loan, lenders can obtain data relating to a given potential debtor's existing APR on tradelines and use the data to make credit extension evaluations. Evaluation leads to fewer had loans and a reduced probability of default for loans in the lender's portfolio.

During the retention phase of a loan, data analyzed from existing APR on tradelines can be used to track a consumer. Based on the trends observed, the lender can make various decisions regarding the consumer relationship.

One of skill in the relevant art(s) will recognize that many of the above described applications of determining existing APR on tradelines may be utilized by other industries and market segments without departing from the spirit and scope of the present invention.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: internal data, client data; merchant data; financial institution data; and/or like data useful in the operation of the system. As those skilled in the art will appreciate, a computer may include an operating system (e.g., Windows NT, 95/98/2000, XP, Vista, OS2, UNIX, Linux, Solaris, MacOS, iOS, Android, etc.) as well as various conventional support software and drivers typically associated with computers. A user may include any individual, business, entity, government organization, software and/or hardware that interact with a system.

A web client includes any device (e.g., personal computer or smartphone or tablet computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, personal computers, such as tablet computers (e.g., tablets running Android, iPads), iMACs, and Mac'looks, kiosks, terminals, point of sale (PUS) devices and/or terminals, televisions, or any other device capable of receiving data over a network. A web-client may run Microsoft Internet Explorer, Mozilla Firefox, Google Chrome, Apple Safari, Opera, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile/XP/Vista/7, OS2, UNIX, Linux, Solaris, MacOS, MacOS X, PalmOS, iOS, Android, etc.) as well as various conventional support software and drivers typically associated with computers. A web client may include any suitable personal computer, network computer, workstation, personal digital assistant, cellular phone, smartphone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, various components, modules, and/or engines of a system may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device), personal digital assistant/smartphone (e.g., iPhone®, Palm Pilot®, Blackberry®, and/or a device running Android), cellular phone, kiosk, etc., online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

As used herein, “issuer” or “credit issuer” may include a bank or other financial institution typically operating under regulations of a card issuing association or entity and which issues cards to cardmembers under a cardmember agreement for a cardmember account.

As used herein, “transmit” may include sending electronic data from one system component to another over a network connection. Additionally, as used herein, “data” may include encompassing information such as commands, queries, files, data for storage, and the like in digital or any other form.

As used herein, “card” includes a transaction instrument such as a charge card, credit card, debit card, awards card, prepaid card, telephone card, smart card, magnetic stripe card, bar code card, transponder, radio frequency card anal/or the like having an account number, which cardholders typically present to Service Establishments (SEs), as part of a transaction, such as a purchase. An “account number”, as used herein, includes any device, code, number, letter, symbol, digital certificate, smart chip, digital signal, analog signal, biometric or other identifier/indicia suitably configured to allow the consumer to interact or communicate with the system, such as, for example, authorization/access code, personal identification number (PIN), Internet code, other identification code, and/or the like which is optionally located on card. The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number “0000 0000 0000 0000”. The first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer.

As used herein, “issue a debit”, “debit” or “debiting” refers to either causing the debiting of a stored value or prepaid card-type financial account, or causing the charging of a credit or charge card-type financial account, as applicable.

Phrases or terms similar to “item” may include any good, service, information, experience, data, content, access, rental, lease, contribution, account, credit, debit, benefit, right, monetary value, non-monetary value and/or the like.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, GPO (GnuPG), PKI, and symmetric and asymmetric cryptosystems. Any form of encryption may be used to implement a secure channel, as described herein.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In various embodiments, the Microsoft Internet information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQ™ (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

The process flows and screenshots illustrated or described are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements, but also to the various system components as described herein.

The computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument.

Phrases similar to a “payment processor” may include a company (e.g., a third party) appointed (e.g., by a merchant) to handle transactions for merchant banks. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing hank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Phrases similar to a “credit approval request” may include a request by a consumer to either a credit issuer for the extension of credit or a financial institution for the disbursal of funds to fund a proposed transaction. The credit issuer may approve the request and fund the transaction or the credit issuer may decline the request. The credit issuer may also approve an amount less than the total amount of the proposed transaction. For example, a credit approval request may comprise a consumer using a transaction card in a proposed transaction with a merchant. Also for example, a credit approval request may comprise a consumer using a transaction card in a proposed transaction with a merchant, wherein the transaction card is a debit card and the financial institution holds a transaction account that holds cash or cash equivalents on behalf of the consumer.

Phrases similar to “vendor software” or “vendor” may include software, hardware and/or a solution provided from an external vendor (e.g., not part of the merchant) to provide value in the payment process (e.g., risk assessment).

As used herein, the meaning of the term “non-transitory computer-readable medium” should be construed to exclude only those types of transitory computer-readable media which were found in In re Nuijten, 500 F.3d 1346 (Fed. Cir. 2007) to fall outside the scope of patentable subject matter under 35 U.S.C. §101, so long as and to the extent In re Nuijten remains binding authority in the U.S. federal courts and is not overruled by a future case or statute. Stated another way, the term “computer-readable medium” should be construed in a manner that is as broad as legally permissible.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, Where a phrase similar to at least one of A, B, and C oar at least one of A, B, ear C is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method comprising
receiving, at an APR determining computer based system, tradeline data associated with a consumer related to a tradeline, wherein the computer based system comprises a processor and a tangible, non-transitory memory;
determining, by the computer based system, payment terms of the tradeline by selecting the greatest of a minimum potential payment amount, a fixed percentage potential payment amount, and a fixed percentage plus finance charge potential payment amount; and
calculating, by the computer based system and in response to selection of the fixed percentage plus finance charge potential payment amount, an APR of the tradeline.

2. The method of claim 1, wherein the calculating the APR further comprises:
subtracting a fixed percentage of a balance of the tradeline from the fixed percentage plus finance charge potential payment amount to obtain a whole finance charge;
subtracting a late fee, a past due amount, and an overlimit charge from the whole finance charge to obtain an interest amount;
dividing the interest amount by the balance to obtain a quotient and multiplying the quotient by 365 divided by the days in a month of a billing cycle of the tradeline.

3. The method of claim 1, further comprising offering the consumer a promotional APR in a balance transfer.

4. The method of claim 1, further comprising offering the consumer a new APR lower than the APR on a new revolving account.

5. The method of claim 1, further comprising at least one of:
calculating, by the computer based system and using the tradeline data, the minimum potential payment amount for the tradeline;
calculating, by the computer based system and using the tradeline data, the fixed percentage potential payment amount for the tradeline; and
calculating, by the computer based system and using the tradeline data, the fixed percentage plus finance charge potential payment amount for the tradeline.

6. The method of claim 1, further comprising determining whether the consumer is a revolver.

7. The method of claim 9, further comprising, in response to determining that the consumer is a revolver, offering a new APR lower than the APR.

8. The method of claim 9, further comprising determining a credit score of the consumer.

9. A system for determining APR, the system comprising:
a non-transitory memory communicating with an APR determining processor,
the non-transitory memory having instructions stored thereon that, in response to execution by the processor, cause the processor to perform operations comprising:
receiving, at an APR determining computer based system, tradeline data associated with a consumer related to a tradeline, wherein the computer based system comprises a processor and a tangible, non-transitory memory;
determining, by the processor, payment terms of the tradeline by selecting the greatest of a minimum potential payment amount, a fixed percentage potential payment amount, and a fixed percentage plus finance charge potential payment amount; and
calculating, by the processor and in response to selection of the fixed percentage plus finance charge potential payment amount, an APR of the tradeline.

10. The system of claim 9, wherein the calculating the APR further comprises:
subtracting a fixed percentage of a balance of the tradeline from the fixed percentage plus finance charge potential payment amount to obtain a whole finance charge;
subtracting a late fee, a past due amount, and an overlimit charge from the whole finance charge to obtain an interest amount;
dividing the interest amount by the balance to obtain a quotient and multiplying the quotient by 365 divided by the days in a month of a billing cycle of the tradeline.

11. The system of claim 9, further comprising offering the consumer a promotional APR in a balance transfer.

12. The system of claim 9, further comprising offering the consumer a new APR lower than the APR on a new revolving account.

13. The system of claim 9, further comprising at least one of:
calculating, by the processor and using the tradeline data, the minimum potential payment amount for the tradeline;
calculating, by the processor and using the tradeline data, the fixed percentage potential payment amount for the tradeline; and
calculating, by the processor and using the tradeline data, the fixed percentage plus finance charge potential payment amount for the tradeline.

14. The system of claim 9, further comprising determining whether the consumer is a revolver.

15. The system of claim 14, further comprising, in response to determining that the consumer is a revolver, offering a new APR lower than the APR.

16. The system of claim 9, further comprising determining a credit score of the consumer.

17. An article of manufacture including a non-transitory computer readable storage medium having instructions stored thereon that, in response to execution by an APR determining processor comprising a non-transitory memory communicating with a processor, cause the processor to perform operations comprising:
receiving, at the processor, tradeline data associated with a consumer related to a tradeline;
determining, by the processor, payment terms of the tradeline by selecting, by a processor, a greatest of the minimum potential payment amount, a fixed percentage potential payment amount, and a fixed percentage plus finance charge potential payment amount; and
calculating, by the processor and in response to selection of the fixed percentage plus finance charge potential payment amount, an APR of the tradeline.

18. The article of manufacture of claim 17, wherein the calculating the APR further comprises:
subtracting a fixed percentage of a balance of the tradeline from the fixed percentage plus finance charge potential payment amount to obtain a whole finance charge;
subtracting a late fee, a past due amount, and an overlimit charge from the whole finance charge to obtain an interest amount; and
dividing the interest amount by the balance to obtain a quotient and multiplying the quotient by 365 divided by the days in a month of a billing cycle of the tradeline.

19. The article of manufacture of claim 17, further comprising offering the consumer a promotional APR in a balance transfer.

20. The article of manufacture of claim 17, further comprising at least one of:
calculating, by the processor and using the tradeline data, the minimum potential payment amount for the tradeline;
calculating, by the processor and using the tradeline data, the fixed percentage potential payment amount for the tradeline; and
calculating, by the processor and using the tradeline data, the fixed percentage plus finance charge potential payment amount for the tradeline.
